(19) United States
(12) Patent Application Publication
(10) Pub. No.: US 2024/0305128 A1
(43) Pub. Date: Sep. 12, 2024

(54) BATTERY CHARGER WITH CHARGING SUPPORT FROM USED BATTERIES (LOW VOLTAGE AND HIGH VOLTAGE)

(71) Applicant: Green Cubes Technology, LLC, Kokomo, IN (US)

(72) Inventors: JOCHEN SCHUMANN, Kokomo, IN (US); MOHAMMED ALOBAIDI, Kokomo, IN (US)

(73) Assignee: Green Cubes Technology, LLC, Kokomo, IN (US)

(21) Appl. No.: 18/272,642

(22) PCT Filed: Jan. 12, 2022
(86) PCT No.: PCT/US2022/012207

§ 371 Date: Jul. 17, 2023

Related U.S. Application Data
(60) Provisional application No. 63/137,931, filed on Jan. 15, 2021.

(51) Int. Cl. H02J 7/34; B60L 53/14; B60L 53/51; B60L 53/53; B60L 53/68; B60L 55/00; H02J 7/35

(52) U.S. Cl. CPC H02J 7/342; B60L 53/14; B60L 53/51; B60L 53/53; B60L 55/00; H02J 7/35; B60L 53/68; B60L 2210/10; B60L 2210/30; H02J 2207/20

(57) ABSTRACT

Fast chargers have recently become widespread due to their ability to reduce charging times. Because of the high power needed from the grid, these chargers need a very complicated infrastructure with high rated components like connectors, cables, and breakers which are not commonly found. Installing a used battery with the charger helps reduce power drawn from the grid as the battery supports the charger to supply the needed power to the load. Therefore, the user can enjoy fast charging without the need to invest in changing their infrastructure. The batteries can also supply power during peak periods when electricity prices are high, which will reduce the user peak demand, thereby reducing the electricity bill. The charger can also be upgraded with a converter to integrate solar panels into the system, where the solar panel supplies the power to the batteries as well as the grid.

### PRIORITY

The present patent application is related to, and claims the priority benefit of, U.S. Provisional Patent Application Ser. No. 63/137,931, filed on Jan. 15, 2021, the contents of which are hereby incorporated by reference in their entirety into this disclosure.

### BACKGROUND

Battery powered vehicles and machines have attracted much attention in the last decade due to their very substantial benefits to the consumer in terms of economic aspect, safety, and maintenance. The main issue facing these vehicles is the charging time. The conventional way of charging is by plugging the battery to the charger for few hours and unplugging it when it finishes charging. This process takes a long time and reduces the efficiency in the work place. Thus, many fast-charging chargers were invented to reduce the charging time, but this is limited to the available infrastructure as the chargers' parts become more complicated and not common (such as power breakers, connectors and fuses) with the increment of the input power.

Thus, there is a need for a fast charging solution that does not require upgrading in-place infrastructure. A solution that utilizes already existing infrastructure and existing components would be well received in the marketplace.

### BRIEF SUMMARY

Issues with current solutions can be mitigated using a used or second-hand battery pack that supports the charger in providing the necessary power to the load (the battery of the vehicle/machine) which leads to reducing the charging time and achieving fast charging. In other words, a 30 kW charger with a battery can deliver 60 kW power to the load with the same infrastructure.

Also, using a battery with a modular charger adds flexibility to the end user to scale-up the chargers with their future load without changing the entire infrastructure as they can add modules to increase the capacity. Moreover, the battery can help to integrate renewable energy resources (RES), such as solar panels, by adding the converter module inside the charger.

Having a battery pack with the charger introduces tremendous features such as peak shaving/load leveling that allows the user (industrial, commercial and residential) to charge the battery at low cost and use the stored energy during the peak demand. Moreover, the battery pack can be utilized to integrate RES such as photovoltaic (PV) panels. The extra power from the RES can be sold back to the grid. The overall power flow can be monitored and controlled using the internet of things (IOT).

The present disclosure includes disclosure of a battery charger, comprising an AC-DC converter that converts AC power from a three phase grid to a DC voltage; a DC-DC converter to step down the DC voltage to a battery voltage; a second DC-DC converter to convert the battery voltage to the DC link voltage; a second-hand battery where the battery used to support the charger to provide the needed power to the load to achieve the fast charging; and a heat dissipation module to reduce the heat of the charger.

The present disclosure includes disclosure of a battery charger, wherein the charger is modular and a power rating of the charger can increase by adding more modules.

The present disclosure includes disclosure of a battery charger, wherein the charger has a converter and solar panels attached to the charger to supply power to the battery and/or reverse power supply to the grid.

The present disclosure includes disclosure of a battery charger, wherein a customer load/vehicle can have a bidirectional DC-DC converter to further step down the power to other voltage range applications as well as the ability to reverse supply the power from a customer's battery to the grid in case of outages.

The present disclosure includes disclosure of a battery charger, wherein a battery module can have a bidirectional DC-DC converter to further step down the power to the other voltage range applications as well as the ability to reverse supply the power from the customer's battery to the grid in case of outages.

The present disclosure includes disclosure of a battery charger, wherein a charger output converter is replaced with a bidirectional DC-AC converter to supply power to the AC loads as well as the customer load supply power back to the grid in case of outages or scheduled maintenance.

The present disclosure includes disclosure of a battery charger, wherein a charger AC output can be single-phase or three-phase.

The present disclosure includes disclosure of a battery charger, wherein the battery's DC-DC converter is bidirectional.

The present disclosure includes disclosure of a battery charger, wherein the battery's AC-DC converter is bidirectional and the used battery and/or the customer load's battery can support power back to the grid.

The present disclosure includes disclosure of a battery charger, wherein both the battery's AC-DC converter and the AC-DC converter are bidirectional and the used battery can support power back to the grid.

The present disclosure includes disclosure of a battery charger, wherein the battery cells of the second-hand battery are connected in series or parallel to get different voltages and capacity configuration.

The present disclosure includes disclosure of a battery charger, wherein the second-hand battery can be replaced with a new battery.

The present disclosure includes disclosure of a battery charger, wherein the charger further comprises Wi-Fi, Bluetooth Low Energy (BLE), and/or GPS therein where the charger is controlled using IOT.

The present disclosure includes disclosure of a battery charger, further comprising an artificial intelligence hub.

The present disclosure includes disclosure of a battery charger, wherein it is not limited for industrial use, and it may be used for commercial users, residential users and other battery powered vehicles and machines.

The present disclosure includes disclosure of a battery charger, wherein the heat dissipation module is fan and/or a heat sink.

The present disclosure includes disclosure of a battery charger, configured for fast charging, peak shaving, load leveling, RES integration and reverse grid supply.

The present disclosure includes disclosure of a battery charging system, comprising an AC-DC module for converting voltage delivered from a power grid to a DC link voltage, a first DC-DC converter for converting the DC link voltage to a desired voltage level; a battery module comprising at least one battery and a battery control interface, the battery module connected to a second DC-DC converter, wherein the second DC-DC converter boosts a battery voltage to the DC link voltage.

The present disclosure includes disclosure of a battery charging system, wherein the power grid is a three phase source.

The present disclosure includes disclosure of a battery charging system, wherein the first DC-DC converter steps down the DC link voltage such that the DC link voltage is a voltage level higher than the desired voltage level.

The present disclosure includes disclosure of a battery charging system, wherein the first DC-DC converter is connected to the at least one battery for charging the at least one battery.

The present disclosure includes disclosure of a battery charging system, wherein the second DC-DC converter is a bidirectional DC-DC converter to both boost the battery voltage to the DC link voltage, and also step down the DC link voltage to the battery voltage for delivery to the battery.

The present disclosure includes disclosure of a battery charging system, wherein the at least one battery is a high voltage battery.

The present disclosure includes disclosure of a battery charging system, wherein the AC-DC module is a bidirectional AC-DC module, wherein the battery module can supply energy back to the power grid through the bidirectional AC-DC module.

The present disclosure includes disclosure of a battery charging system, further comprising a solar panel and solar power converter connected to the battery charging system to supply power to the power grid and/or the at least one battery.

The present disclosure includes disclosure of a battery charging system, wherein the desired voltage level is further converted by a third DC-DC converter before delivery to a customer load, wherein the third DC-DC converter is bidirectional, and wherein the third DC-DC converter can supply voltage to the at least one battery.

The present disclosure includes disclosure of a battery charging system, wherein the desired voltage level is higher than the voltage level received from the AC-DC converter and the battery module.

The present disclosure includes disclosure of a battery charging system, wherein the AC-DC module is a bidirectional AC-DC module, wherein the battery module can supply energy back to the power grid through the bidirectional AC-DC module.

The present disclosure includes disclosure of a battery charging system, further comprising a solar panel and solar power converter connected to the battery charging system to supply power to the at least one battery and/or the power grid.

The present disclosure includes disclosure of a battery charging system, comprising a bidirectional AC-DC module for converting voltage delivered from a power grid to a DC link voltage, a first bidirectional DC-DC converter for converting the DC link voltage to a desired voltage level for delivery to a customer load; a battery module comprising at least one battery and a battery control interface, the battery module connected to a second bidirectional DC-DC converter, wherein the second bidirectional DC-DC converter boosts the battery voltage to the DC link voltage; and a third bidirectional DC-DC converter disposed between the customer load and the first bidirectional DC-DC converter; wherein the first bidirectional DC-DC converter, the third bidirectional DC-DC converter, and the bidirectional AC-DC module can accept power delivered from the customer load to supply power bad to the power grid.

The present disclosure includes disclosure of a battery charging system, further comprising a fourth bidirectional DC-DC converter within the battery module, wherein the fourth bidirectional DC-DC converter steps down voltage delivered from the second bidirectional DC-DC converter before delivery to the at least one battery and steps up voltage delivered to the second bidirectional DC-DC converter from the at least one battery.

The present disclosure includes disclosure of a battery charging system, wherein the desired voltage level is higher than the voltage level received from the AC-DC converter and the battery module.

The present disclosure includes disclosure of a battery charging system, comprising a bidirectional AC-DC module for converting voltage delivered from a power grid to a DC link voltage; a battery module comprising at least one battery and a battery control interface, the battery module connected to a bidirectional DC-DC converter, wherein the bidirectional DC-DC converter boosts the battery voltage to the DC link voltage; and a second bidirectional AC-DC module converter for converting the DC link voltage to a desired AC voltage level for delivery to a customer load.

The present disclosure includes disclosure of a battery charging system, further comprising a solar panel and a solar power converter connected to the battery charging system to supply power to the customer load.

The present disclosure includes disclosure of a battery charging system, wherein the customer load serves as a UPS system to supply power back to the grid during outages or scheduled maintenance.

The present disclosure includes disclosure of a battery charging system, wherein the battery module further comprises a battery interface for controlling the power flow of the battery charging system.

The present disclosure includes disclosure of a battery charging system, wherein the system further comprises Wi-Fi, Bluetooth Low Energy, and a GPS system.

The present disclosure includes disclosure of a battery charging system, wherein the charger is controlled using IOT.

The present disclosure includes disclosure of a battery charging system, wherein the charging system continuously checks the electricity price to determine when to charge and discharge the at least one battery.

The present disclosure includes disclosure of a battery charging system, wherein the at least one battery is a used or secondhand battery.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 illustrates a perspective view of an exemplary embodiment of a modular battery charger including AC-DC module, output DC-DC module, battery module, battery's DC-DC module and Vehicle/load DC-DC module.

FIG. 2 is a schematic diagram of a battery charger with battery charging support.

FIG. 3 is a schematic diagram of a battery charger with HV battery charging support.

FIG. 4 is a schematic diagram of a battery charger with battery charging support and bidirectional power flow to the grid.

FIG. 5 is a schematic diagram of a battery charger with HV battery charging support and bidirectional power flow to the grid.

FIG. 6 is a schematic diagram of a battery charger with battery charging support, bidirectional charging and solar.

FIG. 7 is a schematic diagram of a battery charger with HV battery charging support, bidirectional charging and solar.

FIG. 8 is a schematic diagram of a battery charger with HV battery charging support, bidirectional charging and solar (DC-DC converter in customer load/vehicle).

FIG. 9 is a schematic diagram of a battery charger with battery charging support, bidirectional charging and solar (DC-DC converter in customer load/vehicle).

FIG. 10 is a schematic diagram of a battery charger with HV battery charging support, bidirectional charging and solar (bidirectional DC-AC converter).

FIG. 11 is a schematic diagram of a battery charger with battery charging support, bidirectional charging and solar (DC-DC converter in customer load/vehicle and DC-DC converter inside the battery).

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

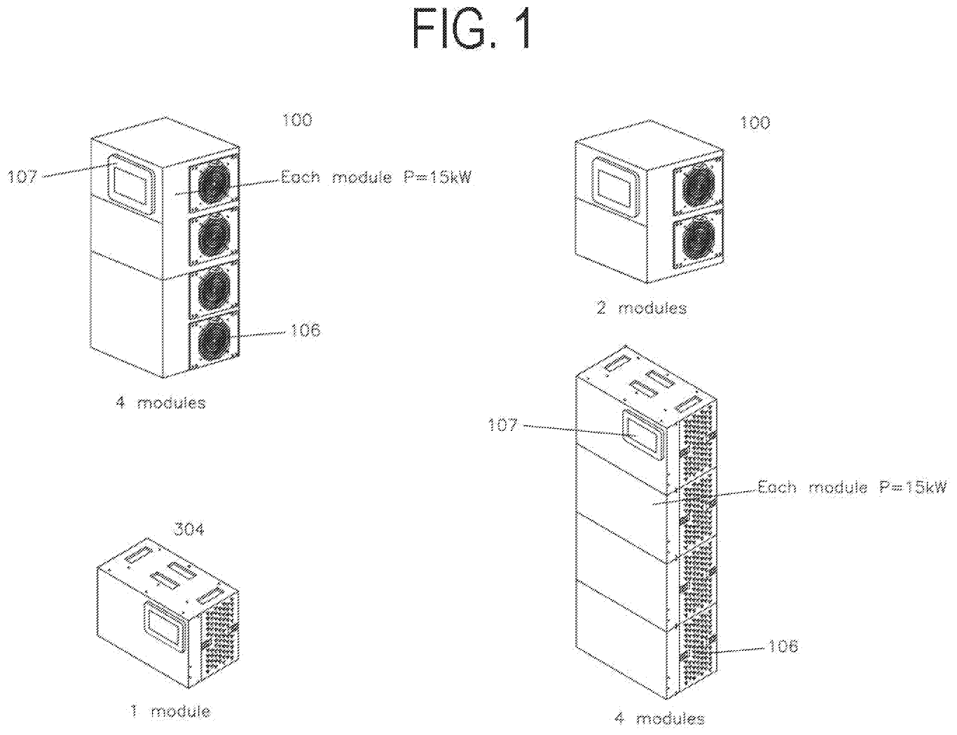

The present disclosure includes a battery charger with new, used, or second-hand battery pack to support the charger in providing the output power needed by the load. Industrial, commercial, and residential customers can enjoy high charger power benefits without worrying about the complicated infrastructure needed for it. Now the users can plug in the battery powered vehicle or machine and let it charge faster with higher power and in a shorter time which increases the efficiency level in the work place. Also, the charger can be easily upgraded to cooperate with the future demand as the user just add on more modules to increase the capacity as shown in FIG. 1. The charger might have a fan 106 to dissipate the heat and a display screen 107 to configure/monitor the charger. A similar modular concept is used in the DC-DC module 304 in the customer's load vehicle.

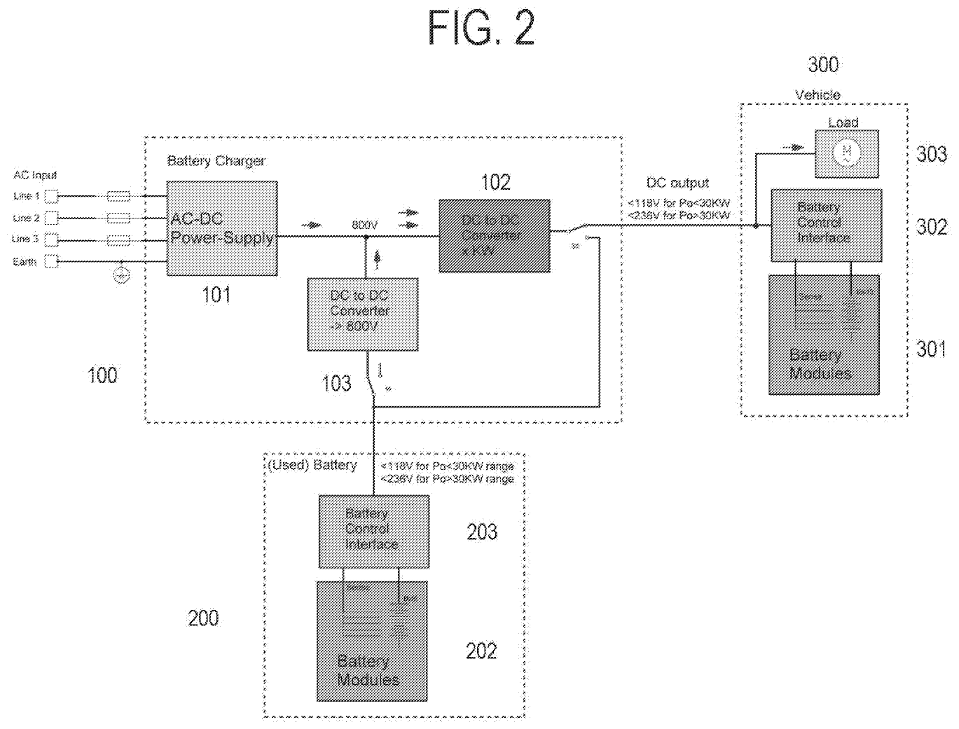

As shown in FIG. 2, the battery charger 100 consists of an AC-DC module 101 to convert the AC voltage from the grid, a DC-DC module 102 to convert the voltage level to the load voltage and another DC-DC converter 103 to be connected to the battery module 200. The battery charger 100 takes the input from the grid through a three-phase source and converts to a high DC voltage (around 800V) using the AC-DC module 101. After that, the DC-DC converter steps down the voltage to customer vehicle/load voltage (for the given example <118V for <30 kW power and >236 V for >30 kW power). The used battery 200 is connected to the battery charger through two paths. In the charging mode, the output DC-DC converter 102 will supply the power to the used battery to store it or later use. On the other hand, in the battery discharge mode power goes through the second DC-DC converter 103 to boost-up the battery voltage (for the given example <118V for <30 kW power and >236 V for >30 kW power) to the DC link voltage (800 V). When the user needs high power charging (fast charging), the power will be supplied from the grid as well as the supporting battery 200. On the other hand, when the charger is not connected to the load, the battery 200 will be charged from the grid.

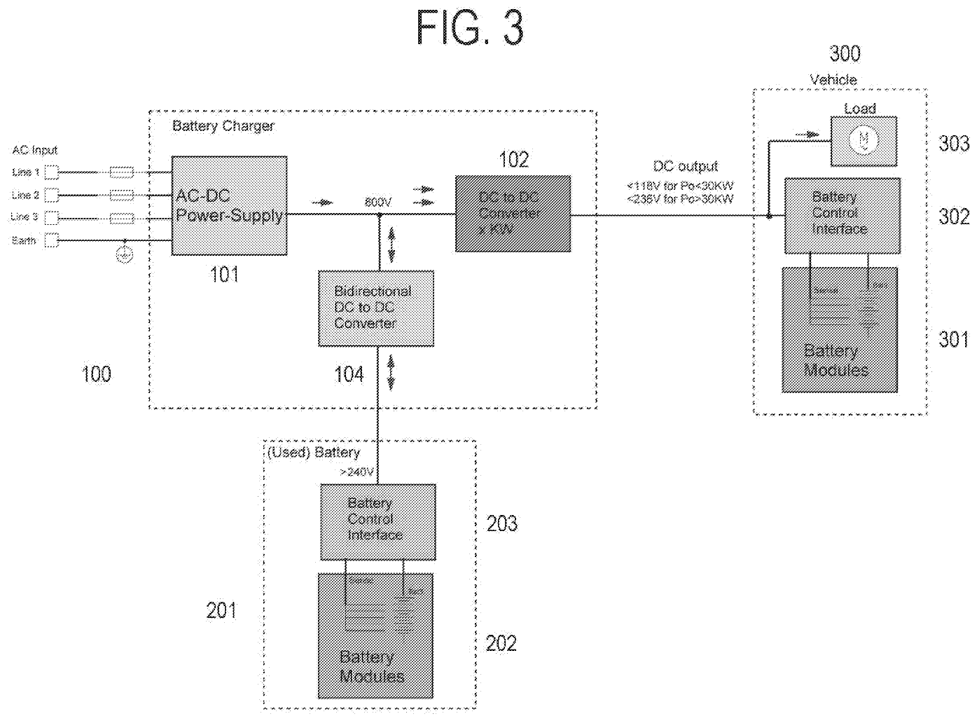

In FIG. 3, the same configuration in FIG. 2 is used but with a high voltage battery 201. In this case, the battery power path will go through a bidirectional DC-DC converter 104 that can boost the battery voltage to the DC-link voltage (for the given example >240 V to 800 V) during the discharge mode and step down the DC-link voltage to the battery voltage (800 to <240 V) in the charging mode.

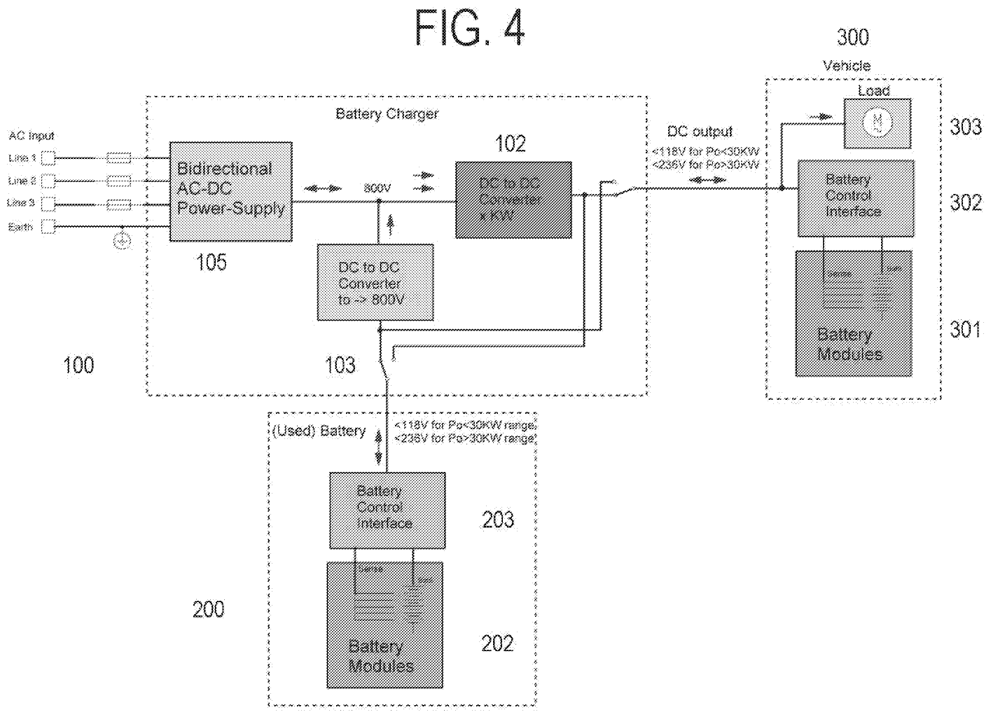

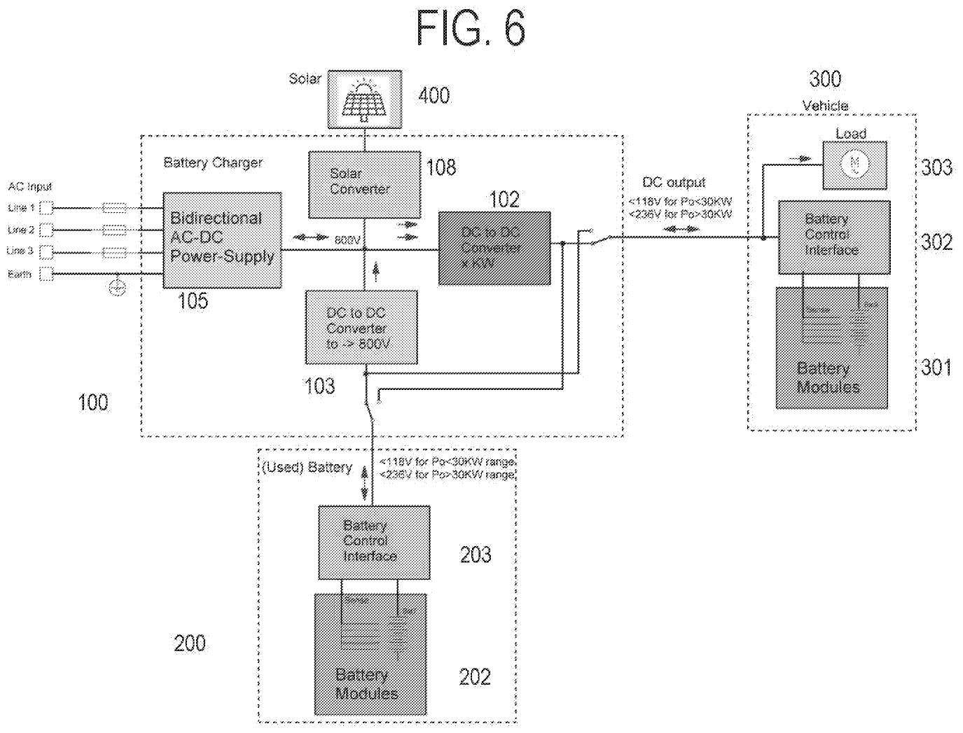

FIG. 4 shows the battery charger 100 with a bidirectional AC-DC converter 105 instead of the one direction AC-DC module 101. This configuration allows reverse grid supply possibility (up to 30 kW for this example) as the charger 100 is supplying back the used battery (200) power and the customer battery (300) power to the grid. This system can be upgraded with a converter 108 and solar panel 400 to serve as another power source to the charger (FIG. 6). By that, the solar power can be used to charge the batteries and/or reverse grid supply power supply possibility.

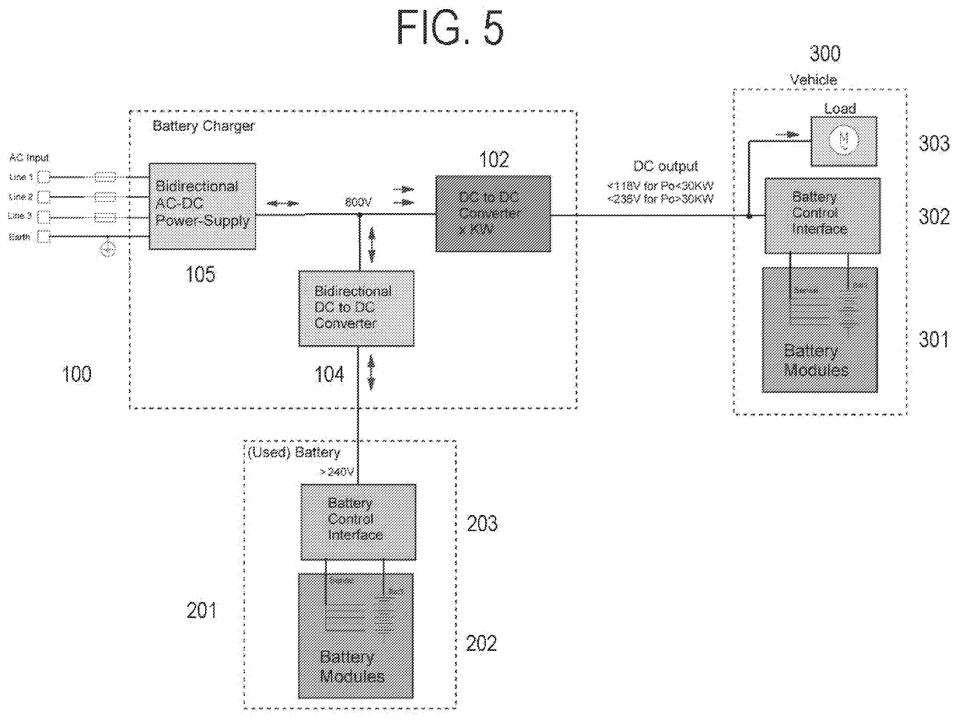

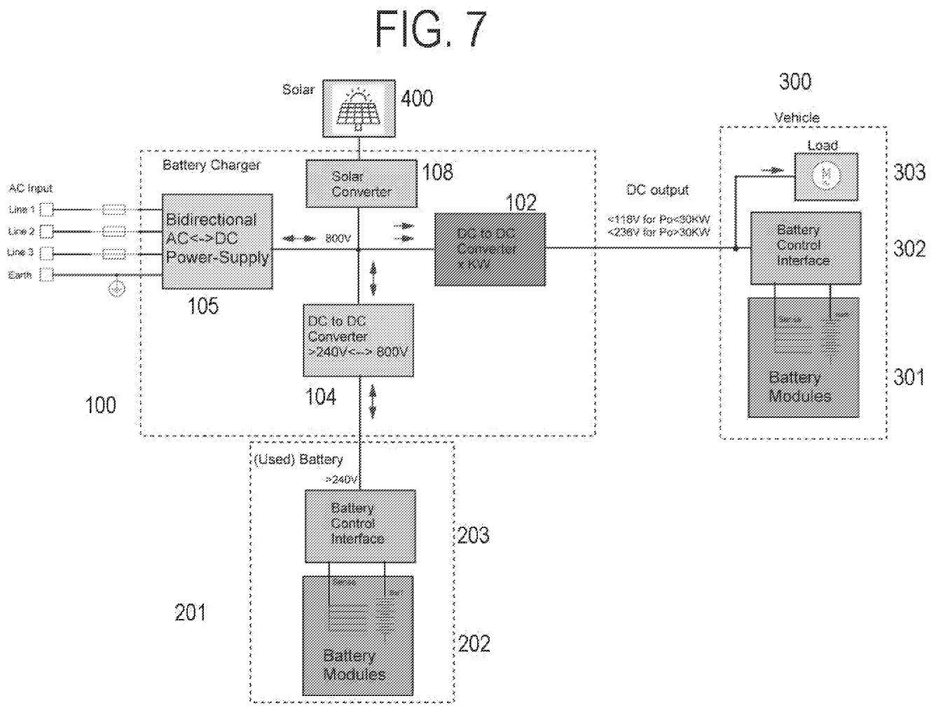

FIG. 5 shows another possible configuration with both AC-DC converter 105 and DC-DC converter 104 being bidirectional. In this case the power flows from the grid and through both AC-DC converter 105 and DC-DC converter 104 to the high voltage battery 201 (charging mode). While the battery 201 can support power back to the grid in the reverse direction. Similar to the previous system, the system in FIG. 5 can be upgraded to have a solar panel 400 and converter 108 as in FIG. 7. The solar system supplies the power to the batteries as well as the grid.

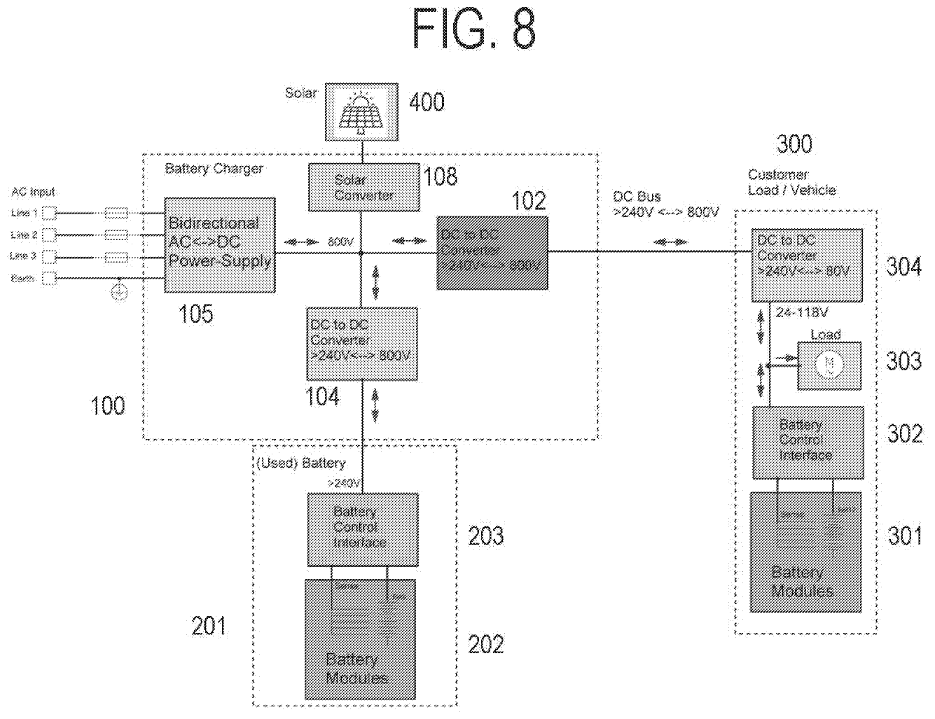

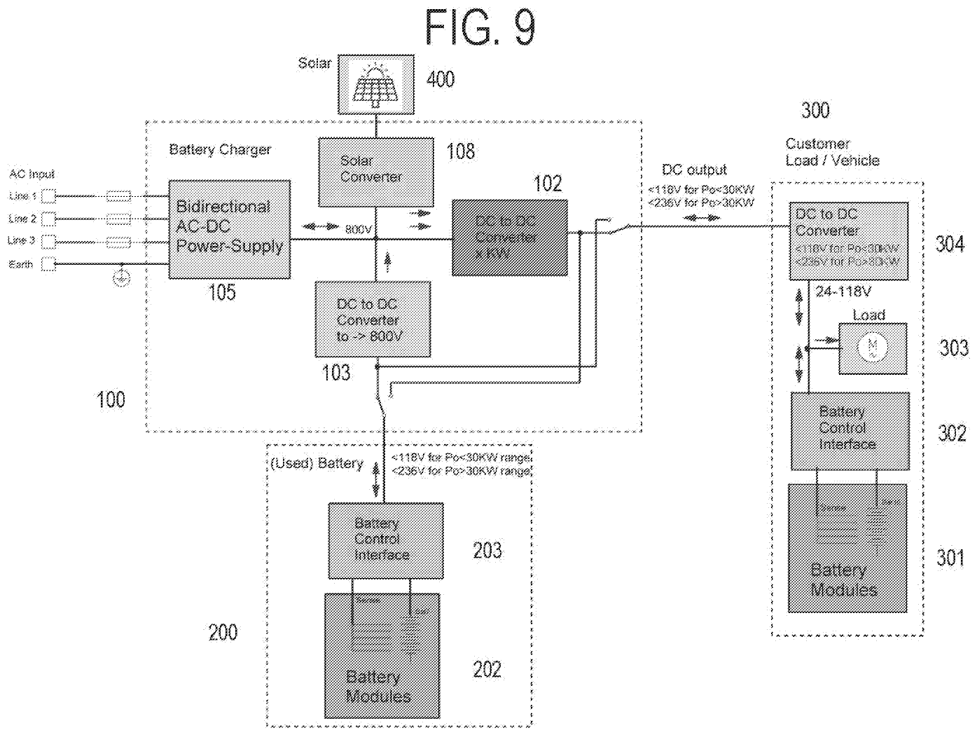

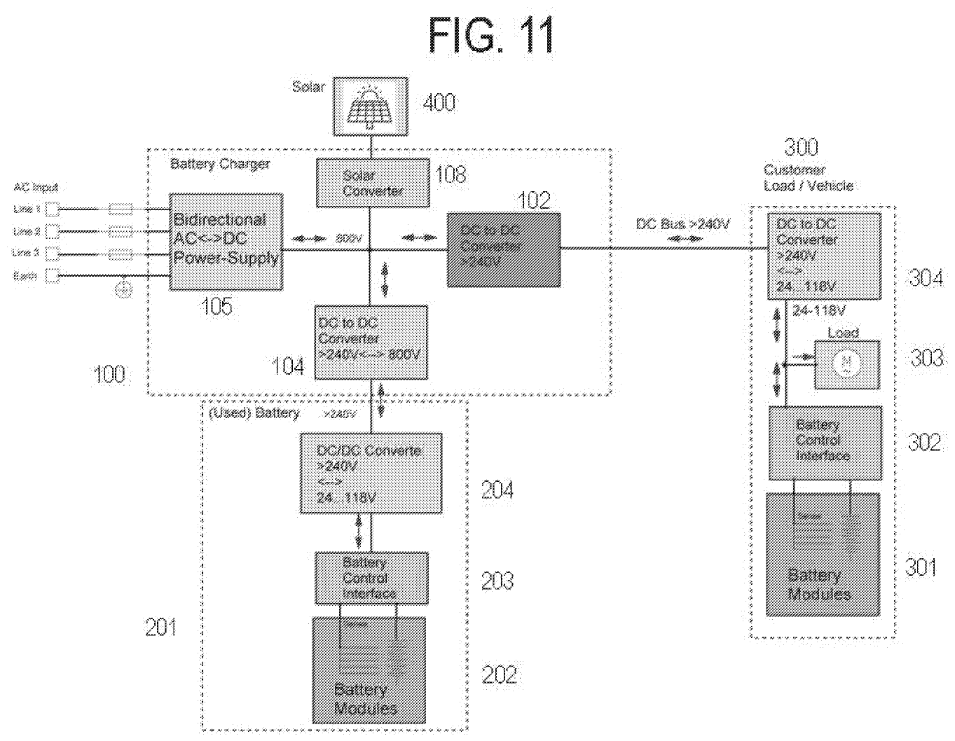

The customer load may consist of battery module 301, battery control interface 302 to control the battery, load 303 (any other loads), and DC-DC converter 304 to convert the power in two directions. In FIG. 8, the customer load/vehicle has a bidirectional DC-DC converter 304 to step down the voltage (for example from >240 V to 80 V and opposite) to support other voltage's range of application. In this case the charger's DC-DC converter 102 can be replaced with bidirectional DC-DC converter so that customer application/vehicle can reverse supply the power back to the grid in case of power outage. Moreover, Another DC-DC converter can be added inside the battery module to further reduce the voltage to support other battery voltage's configuration as in FIG. 11. FIG. 9 shows a similar diagram for the battery charger in FIG. 6 but with the additional bidirectional DC-DC converter 304 in the customer load/vehicle. In this scenario, the output power from the charger can be stepped-down to meet other customer demand in the lower voltage ranges as well as reverse supply to the charger as a UPS system to the grid.

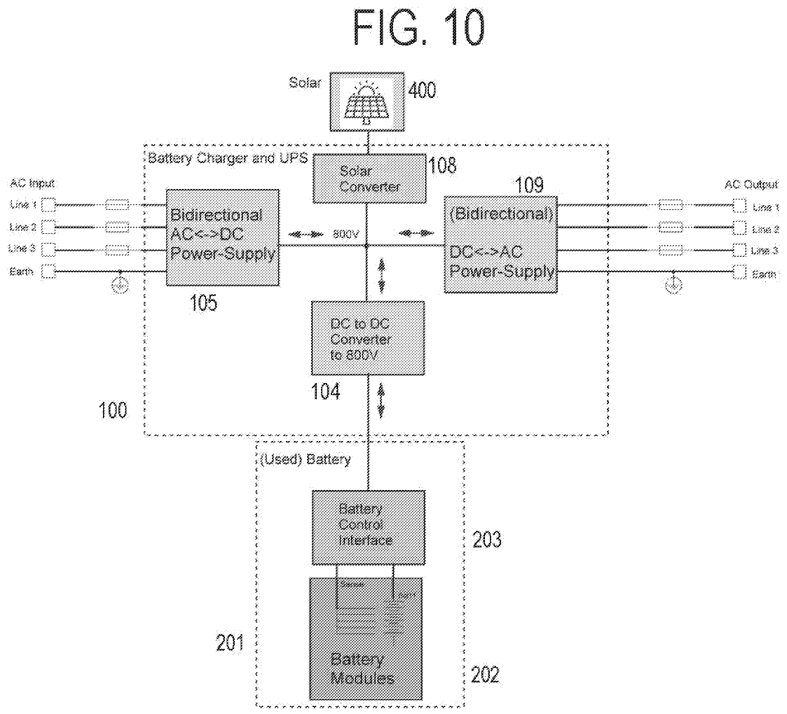

FIG. 10 shows another possible configuration where the charger output is AC (replacing the output DC-DC converter 102 to a bidirectional DC-AC converter 109). The system here supplies AC power to the customer load using 3 different sources which are grid power, solar power, and battery power. These sources will help to reduce the power drawn from the grid which will result in reducing the peak power taken from the grid. Also, the customer load can serve as a UPS system to supply power back to the grid during outages or scheduled maintenance.

The battery module 200 and 201 consist of a battery pack 202 and a battery control interface 203. The use for the second hand (used) batteries is to find a second life for the batteries from other applications and reduce waste. The battery control interface can communicate with the charger to control the power flow. Additionally, The charger 100, the battery 200 and 201 may include Wi-Fi and/or Bluetooth Low Energy (BLE) and/or GPS and/or a GPS locator therein (shown generally as electronic components and/or as computer). The Wi-Fi capability will allow the battery/charger to be controlled using IOT. The BLE capability can communicate the charger's location within the warehouse, while the GPS can transmit the charger's location outside the warehouse. The Wi-Fi capability will be important for integrating the battery/charger with the warehouse's existing technology and software. The Wi-Fi may also help to monitor the charger condition. The Wi-Fi, BLE, and GPS may also help to prevent theft of the charger 100, as its exact position can be monitored/tracked. If lost, the battery/charger can be found using the Wi-Fi, BLE, and GPS.

Although the main benefit from having a battery pack 200 is to support the charger 100 in providing the power to the load (fast charger), the battery can be used to shave the peak power demand during the high demand period (when the load is connected) or selling back the excess power to the grid (when no load is connected) which will significantly reduce the electricity bill for the user. The power flow management between the charger 100, the battery 200 and the load 300 can be controlled using IOT as the charger can continuously check the electricity price and decide when to charge and discharge the used battery 200 to get the best benefit from it.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

1.-17. (canceled)

18. A battery charging system, comprising:
an AC-DC module for converting voltage delivered from a power grid to a DC link voltage, a first DC-DC converter for converting the DC link voltage to a desired voltage level;
a battery module comprising at least one battery and a battery control interface, the battery module connected to a second DC-DC converter, wherein the second DC-DC converter boosts a battery voltage to the DC link voltage.

19. The battery charging system of claim 18, wherein the power grid is a three phase source.

20. The battery charging system of claim 18, wherein the first DC-DC converter steps down the DC link voltage, wherein the DC link voltage is a voltage level higher than the desired voltage level.

21. The battery charging system of claim 18, wherein the first DC-DC converter is connected to the at least one battery for charging the at least one battery.

22. The battery charging system of claim 18, wherein the second DC-DC converter is a bidirectional DC-DC converter to both boost the battery voltage to the DC link voltage, and also step down the DC link voltage to the battery voltage for delivery to the battery.

23. The battery charging system of claim 22, wherein the at least one battery is a high voltage battery.

24. The battery charging system of claim 18, wherein the AC-DC module is a bidirectional AC-DC module, wherein the battery module can supply energy back to the power grid through the bidirectional AC-DC module.

25. The battery charging system of claim 24, further comprising a solar panel and solar power converter connected to the battery charging system to supply power to the power grid and/or the at least one battery.

26. The battery charging system of claim 25 wherein the desired voltage level is further converted by a third DC-DC converter before delivery to a customer load, wherein the third DC-DC converter is bidirectional, and wherein the third DC-DC converter can supply voltage to the at least one battery.

27. The battery charging system of claim 26 wherein the desired voltage level is higher than the voltage level received from the AC-DC converter and the battery module.

28. The battery charging system of claim 22, wherein the AC-DC module is a bidirectional AC-DC module, wherein the battery module can supply energy back to the power grid through the bidirectional AC-DC module.

29. The battery charging system of claim 28, further comprising a solar panel and solar power converter connected to the battery charging system to supply power to the at least one battery and/or the power grid.

30. A battery charging system, comprising:
a bidirectional AC-DC module for converting voltage delivered from a power grid to a DC link voltage, a first bidirectional DC-DC converter for converting the DC link voltage to a desired voltage level for delivery to a customer load;
a battery module comprising at least one battery and a battery control interface, the battery module connected to a second bidirectional DC-DC converter, wherein the second bidirectional DC-DC converter boosts the battery voltage to the DC link voltage; and
a third bidirectional DC-DC converter disposed between the customer load and the first bidirectional DC-DC converter;
wherein the first bidirectional DC-DC converter, the third bidirectional DC-DC converter, and the bidirectional AC-DC module can accept power delivered from the customer load to supply power back to the power grid.

31. The battery charging system of claim 30, further comprising a fourth bidirectional DC-DC converter within the battery module, wherein the fourth bidirectional DC-DC converter steps down voltage delivered from the second bidirectional DC-DC converter before delivery to the at least one battery and steps up voltage delivered to the second bidirectional DC-DC converter from the at least one battery.

32. The battery charging system of claim 30 wherein the desired voltage level is higher than the voltage level received from the AC-DC converter and the battery module.

33. A battery charging system, comprising:
a bidirectional AC-DC module for converting voltage delivered from a power grid to a DC link voltage;
a battery module comprising at least one battery and a battery control interface, the battery module connected to a bidirectional DC-DC converter, wherein the bidirectional DC-DC converter boosts the battery voltage to the DC link voltage; and
a second bidirectional AC-DC module converter for converting the DC link voltage to a desired AC voltage level for delivery to a customer load.

34. The battery charging system of claim 33, further comprising a solar panel and a solar power converter connected to the battery charging system to supply power to the customer load.

35. The battery charging system of claim 33, wherein the customer load serves as a UPS system to supply power back to the grid during outages or scheduled maintenance.

36.-40. (canceled)

41. The battery charging system of claim 18, wherein the battery charging system is modular and a power rating of the battery charging system can be increased by adding a second battery charging system.

42. The battery charging system of claim 41, wherein the at least one battery is a used or second-hand battery.
